(19) United States
(12) Patent Application Publication
(10) Pub. No.: US 2013/0268173 A1
(43) Pub. Date: Oct. 10, 2013

(54) OBJECT DETECTING DEVICE, OBJECT DETECTING METHOD, OBJECT DETECTING PROGRAM, AND MOTION CONTROL SYSTEM

(71) Applicant: HONDA ELESYS CO., LTD., Yokoham-shi (JP)

(72) Inventor: Takeshi KAMBE, Yokohama-shi (JP)

(73) Assignee: Honda elesys Co., Ltd., Yokohama-shi (JP)

(21) Appl. No.: 13/859,346

(22) Filed: Apr. 9, 2013

(30) Foreign Application Priority Data
Apr. 10, 2012 (JP) 2012-089367

(51) Int. Cl. G01S 13/34; G01S 13/93

(52) U.S. Cl. CPC G01S 13/346; G01S 13/931
USPC 701/96; 342/128

(57) ABSTRACT

An object detecting device includes a signal transmitting and receiving unit configured to generate intermediate frequency signals based on transmission signals obtained by frequency modulation in multiple modulation periods and reception signals corresponding to reflected waves of the transmission signals, a distance detecting unit configured to calculate distances based on peak frequencies of the intermediate frequency signals generated by the signal transmitting and receiving unit, and a determination unit configured to determine whether or not the distances calculated by the distance detecting unit and corresponding to the multiple modulation periods are equal to each other.

### CROSS REFERENCE TO RELATED APPLICATIONS

Priority is claimed on Japanese Patent Application No. 2012-089367, filed on Apr. 10, 2012, the contents of which are entirely incorporated herein by reference.

### BACKGROUND OF THE INVENTION

1. Field of the Invention

The present invention relates to an object detecting device, an object detecting method, an object detecting program, and a motion control system.

2. Description of Related Art

A radar apparatus radiates a radio wave (for example, millimeter waves) as a transmission signal and detects an object based on a reception signal obtained by causing the object to reflect the radio wave. An example of such a radar apparatus is a frequency-modulated continuous wave (FM-CW) radar that uses a frequency-modulated transmission signal and calculates the distance or the relative speed to an object using a frequency difference (beat frequency) from a reception signal.

Some FM-CW radars include a device such as a DC-DC converter or a clock generator generating a signal of a constant frequency as noise.

Noise generated from a noise source like this device causes a problem in that the distance or the relative speed to an object which does not really exist is detected depending on the relationship between the noise frequency and the modulation frequency of the transmission signal.

For example, in a method of setting a noise frequency distribution which is described in Japanese Unexamined Patent Application, First Publication No. 2000-338232, a ghost area signal frequency at which the measured distance to a ghost target formed by noise from a noise source is smaller than the measured distance to a real target is set to be higher than the measurable frequency of a signal-passing band.

### SUMMARY OF THE INVENTION

However, in the method of setting a noise frequency distribution described in Japanese Unexamined Patent Application, First Publication No. 2000-338232, since noise other than an existing frequency is not reduced, it is not possible to detect the distance or the relative speed to an object using a frequency component for reducing noise. Therefore, the frequency range in which the distance or the relative speed can be detected is restricted.

The present invention is made in consideration of the above-mentioned circumstances and an object thereof is to provide an object detecting device, an object detecting method, an object detecting program, and a motion control system, which do not restrict detection of a distance or a relative speed.

(1) According to an aspect of the present invention, an object detecting device is provided including: a signal transmitting and receiving unit configured to generate intermediate frequency signals based on transmission signals obtained by frequency modulation in multiple modulation periods and reception signals corresponding to reflected waves of the transmission signals; a distance detecting unit configured to calculate distances based on peak frequencies of the intermediate frequency signals generated by the signal transmitting and receiving unit; and a determination unit configured to determine whether or not the distances calculated by the distance detecting unit and corresponding to the multiple modulation periods are equal to each other.

(2) In the object detecting device, the determination unit may determine that the distances are based on a real image when the distances are determined to be equal to each other, and may determine that the distances are not based on a real image and are invalid when the distances are determined to not be equal to each other.

(3) The object detecting device may further include a received intensity calculating unit configured to determine whether or not the peak frequencies are equal to each other.

(4) In the object detecting device, the received intensity calculating unit may determine that the peak frequencies are based on noise and are invalid when the peak frequencies are determined to be equal to each other.

(5) In the object detecting device, the signal transmitting and receiving unit may switch a period used in frequency modulation of the transmission signals from one to another of the multiple modulation periods at a predetermined time interval.

(6) In the object detecting device, the signal transmitting and receiving unit may include: transmitting units allotted to each of the multiple modulation periods and configured to transmit the transmission signals; and receiving units allotted to each of the multiple modulation periods and configured to receive the reflected waves.

(7) According to another aspect of the present invention, an object detecting method is provided including: a first step of generating intermediate frequency signals based on transmission signals obtained by frequency modulation in multiple modulation periods and reception signals corresponding to reflected waves of the transmission signals; a second step of calculating distances based on peak frequencies of the intermediate frequency signals; and a third step of determining whether or not the distances corresponding to the multiple modulation periods are equal to each other.

(8) According to still another aspect of the present invention, an object detecting program is provided which causes a computer of an object detecting device to perform: a sequence of generating intermediate frequency signals based on transmission signals obtained by frequency modulation in multiple modulation periods and reception signals corresponding to reflected waves of the transmission signals; a sequence of calculating distances based on peak frequencies of the intermediate frequency signals; and a sequence of determining whether or not the distances corresponding to the multiple modulation periods are equal to each other.

(9) According to still another aspect of the present invention, a motion control system is provided including an object detecting device and a motion control unit configured to control a motion based on a distance or a speed of an object input from the object detecting device, wherein the object detecting device includes: a signal transmitting and receiving unit configured to generate intermediate frequency signals based on transmission signals obtained by frequency modulation in multiple modulation periods and reception signals corresponding to reflected waves of the transmission signals; a distance detecting unit configured to calculate distances based on peak frequencies of the intermediate frequency signals generated by the signal transmitting and receiving unit; and a determination unit configured to determine whether or not the distances calculated by the distance detecting unit and corresponding to the multiple modulation periods are equal to each other.

According to the present invention, detection of a distance or a relative speed is not restricted.

### BRIEF DESCRIPTION OF THE DRAWINGS

FIG. 1 is a diagram schematically illustrating a configuration of a motion control system according to an embodiment of the present invention.

FIG. 2 is a diagram schematically illustrating a configuration of an object detecting device according to the embodiment.

FIG. 3 is a diagram illustrating examples of a transmission signal and a reception signal according to the embodiment.

FIG. 4 is a diagram illustrating an example of a level vs. frequency characteristic of an IF signal.

FIG. 5 is a diagram illustrating an example of a frequency characteristic of a transmission signal.

FIG. 6 is a diagram illustrating another example of a level vs. frequency characteristic of an IF signal.

FIG. 7 is a diagram illustrating an example of a level vs. distance characteristic of an IF signal.

FIG. 8 is a conceptual diagram illustrating an arrangement of receiving antennas according to the embodiment.

FIG. 9 is a flowchart illustrating an object detecting process according to the embodiment.

FIG. 10 is a flowchart illustrating a real image determining process according to the embodiment.

FIG. 11 is a diagram schematically illustrating a configuration of an object detecting device according to another embodiment of the present invention.

### DETAILED DESCRIPTION OF THE INVENTION

### First Embodiment

Hereinafter, an embodiment of the present invention will be described with reference to the accompanying drawings.

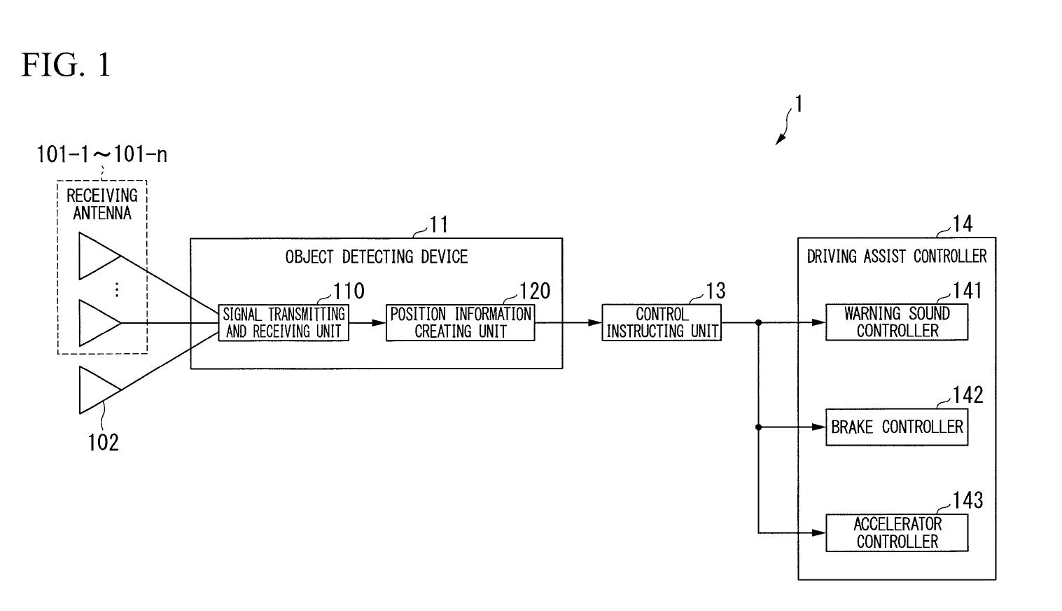

FIG. 1 is a diagram schematically illustrating a configuration of a motion control system 1 according to this embodiment.

The motion control system 1 includes n (where n is an integer greater than 1) receiving antennas 101-1 to 101-n, a transmitting antenna 102, an object detecting device 11, a control instructing unit 13, and a driving assist controller 14. For example, the motion control system 1 controls a motion mechanism of a vehicle or presentation of information to a driver of the vehicle.

The object detecting device 11 includes a signal transmitting and receiving unit 110 and a position information creating unit 120.

The signal transmitting and receiving unit 110 generates a transmission signal and outputs the generated transmission signal to the transmitting antenna 102 that radiates radio waves. The signal transmitting and receiving unit 110 generates an intermediate frequency (IF) signal based on a reception signal input from the receiving antennas 101-1 to 101-n that receive a radio wave reflected by an object as a reception signal and the transmission signal. Here, the signal transmitting and receiving unit 110 generates transmission signals whose frequencies are modulated in multiple modulation periods. The signal transmitting and receiving unit 110 outputs the input reception signal and the generated IF signal to the position information creating unit 120. The configuration of the signal transmitting and receiving unit 110 will be described later.

The position information creating unit 120 calculates distances, an orientation, and a relative speed for each target based on the IF signal input from the signal transmitting and receiving unit 110. A target is information representing a detected object. The position information creating unit 120 creates position information representing the calculated distance, the calculated orientation, and the calculated relative speed for each target.

The position information creating unit 120 determines whether or not the distances corresponding to the multiple modulation periods are equal to each other, and outputs the position information of the target, on which the distances are determined to equal to each other, to the control instructing unit 13. The configuration of the position information creating unit 120 will be described later.

The control instructing unit 13 generates a control signal for controlling the operation of the driving assist controller 14 based on the position information of each target input from the position information creating unit 120. The control instructing unit 13 generates the control signal, for example, when a target whose distance represented by the input position information is smaller than a predetermined first threshold value is included. The control instructing unit 13 outputs the generated control signal to the driving assist controller 14.

The driving assist controller 14 controls the function of assisting the driving of a vehicle based on the control signal input from the control instructing unit 13. The driving assist controller 14 includes, for example, a warning sound controller 141, a brake controller 142, and an accelerator controller 143. The warning sound controller 141 outputs a warning sound for warning a driver of an approach of an object when the control signal is input. The brake controller 142 starts a braking operation to decelerate the vehicle, when the control signal is input and the braking operation is not performed.

The accelerator controller 143 stops an accelerating operation to stop the acceleration of the vehicle, when the control signal is input and the accelerating operation is performed.

The configuration of the signal transmitting and receiving unit 110 will be described below.

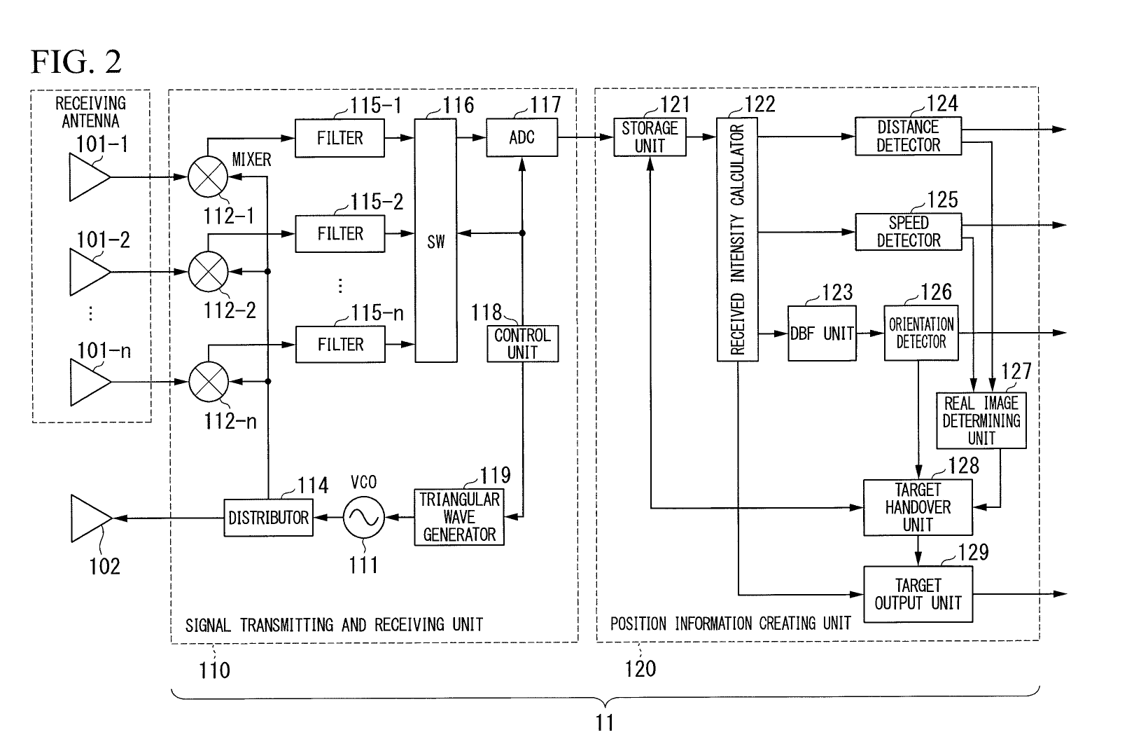

FIG. 2 is a diagram schematically illustrating the configuration of the object detecting device 11 according to this embodiment.

The signal transmitting and receiving unit 110 includes a VCO (Voltage-Controller Oscillator) 111, n mixers 112-1 to 112-n, a distributor 114, n filters 115-1 to 115-n, a SW (switch) 116, an ADC (an A/D (Analog-to-Digital) converter, a received wave acquiring unit) 117, a control unit 118, and a triangular wave generator 119.

The VCO 111 generates a signal of a predetermined frequency and frequency-modulate the generated signal based on a triangular wave signal input from the triangular wave generator 119 to generate a transmission signal. The VCO 111 outputs the generated transmission signal to the distributor 114. The transmission signal generated by the VCO 111 is frequency-modulated with a frequency modulation width Δf centered on a predetermined central frequency f₀ in the modulation period of the triangular wave signal. Therefore, the transmission signal has an ascending portion in which the frequency increases with the lapse of time and a descending portion in which the frequency decreases.

The mixers 112-1 to 112-n mix reception signals input from the receiving antennas 101-1 to 101-n with the transmission signal input from the distributor 114 to generate IF signals. The IF signals are also referred to as beat signals. Channels corresponding to the receiving antennas 101-1 to 11-n are also referred to as CH-1 to CH-n. The frequency of the IF signal is a difference (beat frequency) between the frequency of the corresponding reception signal and the frequency of the transmission signal.

The mixers 112-1 to 112-n output the generated IF signals of CH-1 to CH-n to the filters 115-1 to 115-n.

The distributor 114 outputs the transmission signal input from the VCO 111 to the transmitting antenna 102 and the mixers 112-1 to 112-n.

The filters 115-1 to 115-n band-limit the IF signals of CH-1 to CH-n input from the mixers 112-1 to 112-n and output the band-limited IF signals to the SW 116.

The SW 116 outputs the IF signals of CH-1 to CH-n input from the filters 115-1 to 115-n to the ADC 117 while sequentially switching the channels in synchronization with a sampling signal input from the control unit 118.

The ADC 117 converts the analog IF signals, whose channels are sequentially switched and which are input from the SW 116, to digital IF signals at a predetermined sampling frequency and sequentially stores the converted IF signals in the storage unit 121 of the position information creating unit 120.

The control unit 118 controls the units of the object detecting device 11. The control unit 118 is, for example, a central processing unit (CPU).

The control unit 118 generates a sampling signal of a predetermined sampling period and outputs the generated sampling signal to the SW 116, the ADC 117, and the triangular wave generator 119.

The triangular wave generator 119 generates a triangular wave signal with any one modulation period of plural predetermined modulation periods and outputs the generated triangular wave signal to the VCO 111.

The triangular wave is a waveform in which the amplitude linearly increases from a predetermined minimum value to a predetermined maximum value in a certain modulation period, reaches the maximum value, and then linearly decreases from the maximum value to the minimum value. The triangular wave generator 119 alternately switches the modulation period of a triangular wave signal to be generated, for example, to any one of two modulation periods Tₐ and T_{b} (T_{b}>Tₐ). Accordingly, the triangular wave generator 119 alternately switches the modulation period of the transmission signal, which is generated by the VCO 111, to any one of Tₐ and T_{b}. In the following description, the transmission signal in a section in which the modulation period is Tₐ is referred to as modulated wave “a”.

The transmission signal in a section in which the modulation period is T_{b} is referred to as modulated wave “b”. The period in which the modulation period is switched is referred to as a switching period T_{ab}.

The configuration of the position information creating unit 120 will be described below.

The position information creating unit 120 includes a storage unit 121, a received intensity calculator 122, a DBF (Digital Beam Forming) unit 123, a distance detector 124, a speed detector 125, an orientation detector 126, a real image determining unit 127, a target handover unit 128, and a target output unit 129.

The received intensity calculator 122 reads the IF signal for each channel from the storage unit 121, for example, Fourier-transforms the read IF signals, and calculates complex data of a frequency domain. The received intensity calculator 122 outputs the calculated complex data for each channel to the DBF unit 123.

The received intensity calculator 122 calculates a spectrum based on a sum value obtained by adding the complex data of all the channels. The received intensity calculator 122 may calculate a spectrum based on complex data of a certain channel, but can average a noise component to improve an S/N (Signal-to-Noise) ratio by calculating a spectrum based on the sum value.

The received intensity calculator 122 detects a portion at which the level is a maximum greater than a threshold value of a predetermined level as a peak of a signal level for each of the ascending portion and the descending portion from the calculated spectrum (peak detection). The received intensity calculator 122 performs the peak detection in each of the modulation periods Tₐ and T_{b} for each switching period T_{ab}. The received intensity calculator 122 creates peak frequency information representing the frequency of the peak detected in each of the modulation periods Tₐ and T_{b}. The received intensity calculator 122 outputs the created peak frequency information to the distance detector 124 and the speed detector 125.

The received intensity calculator 122 may determine whether the peak frequency corresponding to the modulation period Tₐ is equal to the peak frequency corresponding to the modulation period T_{b}. Here, the received intensity calculator 122 determines that both are equal, for example, when the absolute value in difference between the peak frequency corresponding to the modulation period Tₐ and the peak frequency corresponding to the modulation period T_{b} is smaller than a predetermined threshold value of the difference. The received intensity calculator 122 may eliminate the peak frequency information representing the peak frequency determined to be equal in both modulation periods, and may output the peak frequency information representing the other peak frequency to the distance detector 124 and the speed detector 125. Accordingly, it is possible to remove the influence of noise including the same frequency component regardless of the modulation periods Tₐ and T_{b}.

The received intensity calculator 122 creates position information representing that a target is not detected and output the created position information to the target output unit 129, when any peak is not detected.

The DBF unit 123 further Fourier-transforms (spatial-axis Fourier-transforms) the complex data for each channel input from the received intensity calculator 122 in the arrangement direction (channel direction) of the antennas and creates complex data of a spatial frequency domain. The DBF unit 123 calculates received intensity which is spectral intensity for each angular channel of a predetermined angle resolution from the created complex data and creates received intensity information representing the calculated received intensity. The DBF unit 123 outputs the created received intensity information to the orientation detector 126.

The distance detector 124 calculates a distance to an object represented by each target in each of the modulation periods Tₐ and T_{b} based on the frequency fᵤ of the ascending portion and the frequency f_{d} of the descending portion represented by the peak frequency information input from the received intensity calculator 122. The distance detector 124 calculates the distance R, for example, using Equation (1).

$$R = \frac{c \cdot T}{2 Δ f} \cdot \frac{{f}_{u} + {f}_{d}}{2} \qquad ( 1 )$$

In Equation (1), “c” represents the light speed and T represents the modulation period. That is, Equation (1) represents that the distance c·T/2 by which light travels within the elapsed time T/2 of the ascending portion or the descending portion is multiplied by the ratio of an average value of the frequency fₐ of the ascending portion and the frequency f_{d} of the descending portion for each target to the modulation frequency Δf to obtain the distance R. The distance detector 124 outputs distance information representing the distance to an object represented by each target in each of the modulation periods Tₐ and T_{b} to the real image determining unit 127.

The speed detector 125 calculates a relative speed to an object represented by each target in each of the modulation periods Tₐ and T_{b} based on the frequency fᵤ, of the ascending portion and the frequency f_{d} of the descending portion represented by the peak frequency information input from the received intensity calculator 122. The speed detector 125 calculates the speed V, for example, using Equation (2).

$$V = \frac{c}{2 \cdot {f}_{0}} \cdot \frac{{f}_{u} - {f}_{d}}{2} \qquad ( 2 )$$

That is, Equation (2) represents that the light speed c is multiplied by a ratio of the difference between the frequency fᵤ of the ascending portion and the frequency f_{d} of the descending portion to the central frequency f₀ to obtain the relative speed V. The speed detector 125 outputs speed information representing the relative speed V of each target in each of the modulation periods Tₐ and T_{b} to the real image determining unit 127.

The orientation detector 126 detects an angle φ at which the received intensity represented by the received intensity information input from the DBF unit 123 is a maximum as the orientation of an object represented by the corresponding target and creates orientation information representing the detected orientation. The orientation detector 126 outputs the created orientation information to the target handover unit 128.

The distance information is input to the real image determining unit 127 from the distance detector 124. The real image determining unit 127 determines whether the distance of each target in the modulation period Tₐ and the distance of the corresponding target in the modulation period T_{b} represented by the input distance information are equal to each other. Here, the real image determining unit 127 determines that the calculated distances are equal to each other, for example, when it is determined that the absolute value of the difference between the distances of each target in the modulation period Tₐ and the distance of the corresponding target in the modulation period T_{b} represented by the distance information is smaller than a predetermined threshold value of the difference. The real image determining unit 127 stores the distance information of the target on which the calculated distances are determined to be equal to each other as distance information of a real image. A real image is a target representing the peak of the frequency characteristic of the IF signal based on the reflected wave from an object. The real image determining unit 127 determines the distance information of a target on which the calculated distances are determined to not be equal to each other to be distance information of a virtual image and eliminates and does not employ the distance information. A virtual image is a target representing the peak of a frequency component other than the real image, for example, a noise component mixed into the IF signal or a frequency difference component between the IF signal and the noise component. In the following description, when it is mentioned that two values are equal to each other, it may mean that the absolute value of the difference between both values is smaller than a predetermined threshold value, as well as that two values are strictly equal to each other. Accordingly, even when a small difference such as an error occurs in two values due to an observation error, both values are considered to be equal to each other.

The speed information is input to the real image determining unit 127 from the speed detector 125. The real image determining unit 127 stores the speed information of the target associated with the stored distance information as speed information of a real image. The real image determining unit 127 determines the speed information of the target on which the calculated distances are determined to not be equal to each other to be speed information of a virtual image and eliminates and does not employ the speed information.

The real image determining unit 127 outputs the distance information stored as the distance information of a real image and the speed information thereof to the target handover unit 128.

The distance information and the speed information from the real image determining unit 127 and the orientation information from the orientation detector 126 are input to the target handover unit 128. The target handover unit 128 reads the distance information, the speed information, and the orientation information in the previous switching period from the storage unit 121. The target handover unit 128 determines whether difference values between the distance, the relative speed, and the orientation calculated in the current switching period and the distance, the relative speed, and the orientation calculated in the previous switching period are smaller than predetermined threshold values of the difference values. When it is determined that all the difference values are smaller than the predetermined threshold values, the target handover unit 128 determines that the target in the current switching period and the target in the previous switching period are the same. In this case, the target handover unit 128 increases a target handover number of the target by 1, and stores the target in the storage unit 121 in correlation with the distance information, the speed information, and the orientation information in the current switching period. The target handover unit 128 outputs the target to the target output unit 129 in correlation with the distance information, the speed information, and the orientation information in the current switching period.

When it is determined that the target in the current switching period and the target in the previous switching period are not equal to each other, the target handover unit 128 determines that a new object is detected. The target handover unit 128 creates a target (identification number) representing the new object and stores the created target in the storage unit 121 in correlation with the distance information, the speed information, and the orientation information in the current switching period. The target handover unit 128 outputs the target to the target output unit 129 in correlation with the distance information, the speed information, and the orientation information in the current switching period. Hereinafter, the distance information, the speed information, and the orientation information may be generically referred to as position information.

The target output unit 129 outputs the position information input from the received intensity calculator 122 or the target handover unit 128 to the control instructing unit 13.

### Detection of Distance and Relative Speed

The principle in which the position information creating unit 120 detects the distance and the relative speed will be described below.

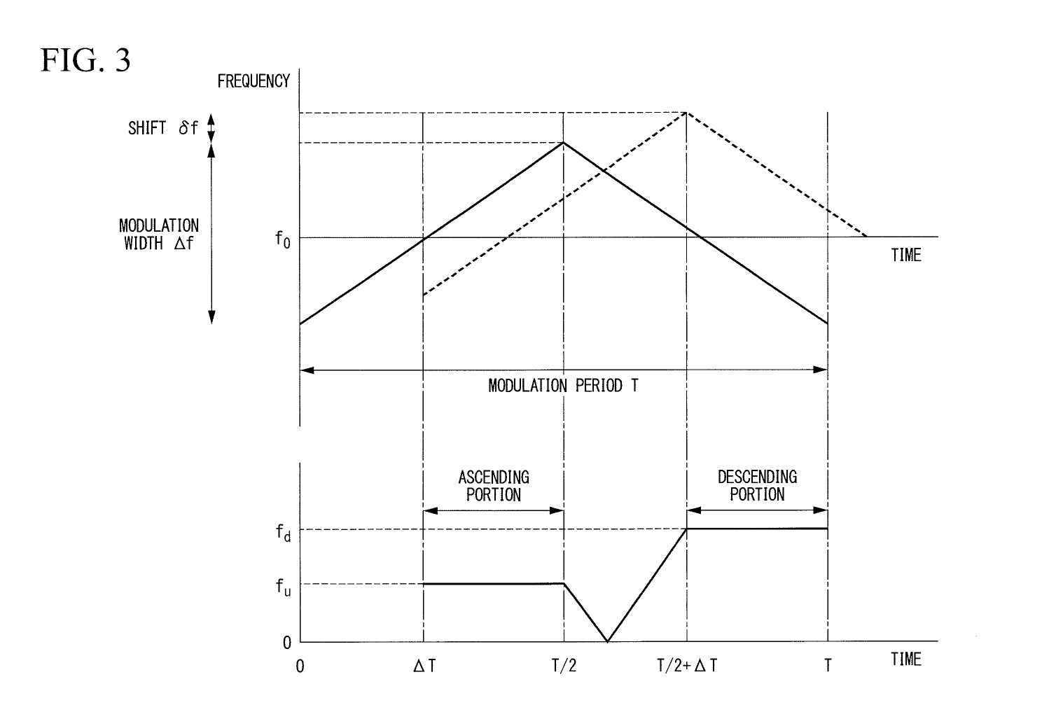

FIG. 3 is a diagram illustrating an example of a transmission signal and a reception signal according to this embodiment.

In FIG. 3, the horizontal axis represents the time and the vertical axis represents the frequency. In the example shown in FIG. 3, the modulation period of the transmission signal is defined as T.

In the upper part of FIG. 3, the frequency of the transmission signal is indicated by a solid line and the frequency of the reception signal is indicated by a broken line. The transmission signal is frequency-modulated with a modulation width Mf centered on the central frequency f₀. In the example shown in FIG. 3, the reception signal is frequency-shifted by δf with a delay of ΔT. The delay ΔT represents a delay until a reflected wave reflected by the object is received after the transmission signal is transmitted. The shift δf is based on the Doppler effect due to occurrence of the relative speed V to an object. Therefore, as the distance R to the object increases, the delay time ΔT increases, and as the relative speed to an object increases, the frequency shift δf increases.

In the lower part of FIG. 3, the frequency of an IF signal is indicated by a solid line. The frequency of the IF signal is an absolute value of a difference between the frequency of the reception signal and the frequency of the transmission signal. The frequency of the IF signal shown in the lower part of FIG. 3 is the frequency of the peak detected by the received intensity calculator 122. In the ascending portion, the frequency of the IF signal is L. The ascending portion is a section in which the frequencies of both the transmission signal and the reception signal rise with the lapse of time. In FIG. 3, the ascending portion is from time ΔT to time T/2. In the descending portion, the frequency of the IF signal is f_{d}. The descending portion is a section in which the frequencies of both the transmission signal and the reception fall with the lapse of time. In FIG. 3, the descending portion is from time T/2+ΔT to time T. The modulation width Δf and the frequency shift δf are determined by the frequency fᵤ of the ascending portion and the frequency f_{d} of the descending portion. Therefore, in this embodiment, it is possible to calculate the distance R and the relative speed V based on the frequency fᵤ of the ascending portion and the frequency f_{d} of the descending portion detected by the received intensity calculator 122.

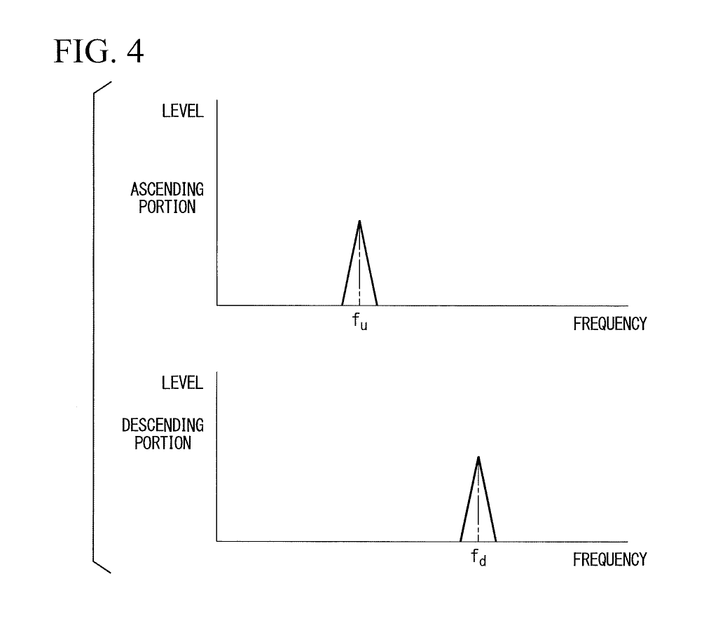

FIG. 4 is a diagram illustrating an example of a level vs. frequency characteristic of an IF signal.

In FIG. 4, the horizontal axis represents the frequency and the vertical axis represents the level.

The upper part of FIG. 4 shows the level of an IF signal in the ascending portion. The level of the IF signal has a peak at the frequency fᵤ of the ascending portion. The lower part of FIG. 4 shows the level of the IF signal in the descending portion. The level of the IF signal has a peak at the frequency f_{d} of the descending portion.

The received intensity calculator 122 may detect frequencies of peaks corresponding to plural targets. In this case, the received intensity calculator 122 creates peak frequency information in correlation with a common target in the order of increasing the frequency for each of the ascending portion and the descending portion, and outputs the created peak frequency information to the distance detector 124 and the speed detector 125.

### Switching of Modulation Period

The frequency modulation of the transmission signal generated by the VCO 111 will be described below.

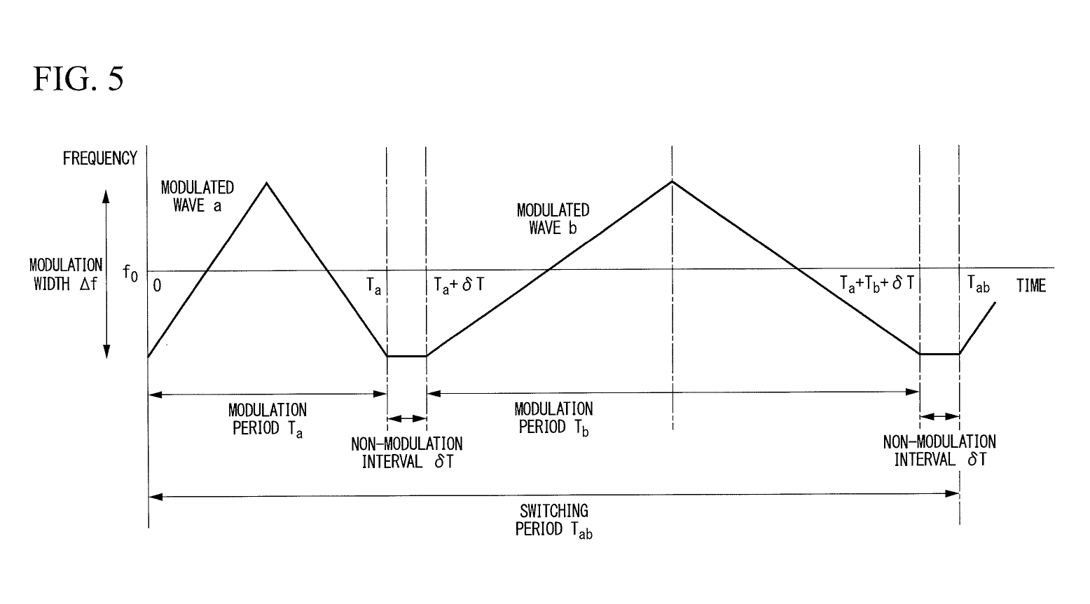

FIG. 5 is a diagram illustrating an example of a frequency characteristic of a transmission signal.

In FIG. 5, the horizontal axis represents the time and the vertical axis represents the frequency. The transmission signal is frequency-modulated with a modulation width Δf centered on the central frequency f₀. Here, the modulation period of the transmission signal is switched between the modulation periods Tₐ and T_{b} at a predetermined switching period T_{ab}. A non-modulation section in which the frequency is constant is interposed between the modulated wave “a” of the modulation period Tₐ and the modulated wave “b” of the modulation period T_{b}. The length of the non-modulation section is referred to as a non-modulation interval δT. FIG. 5 shows modulated wave “a” of the modulation period Tₐ between time 0 and time Tₐ, and shows modulated wave “b” of the modulation period T_{b} between time Tₐ+δT and time Tₐ+T_{b}+δT. FIG. 5 shows the non-modulation interval δT between time Tₐ to time Tₐ+δT and between time Tₐ+T_{b}+δT to time T_{ab}. In the example shown in FIG. 5, the switching period T_{ab} is Tₐ+T_{b}+2·δT. Therefore, the received intensity calculator 122 detects the peak frequency of each of the ascending portion and the descending portion of the IF signal based on the modulated wave “a” and the modulated wave “b”.

The level vs. frequency characteristic of the IF signal based on the transmission signal whose modulation period is switched will be described below.

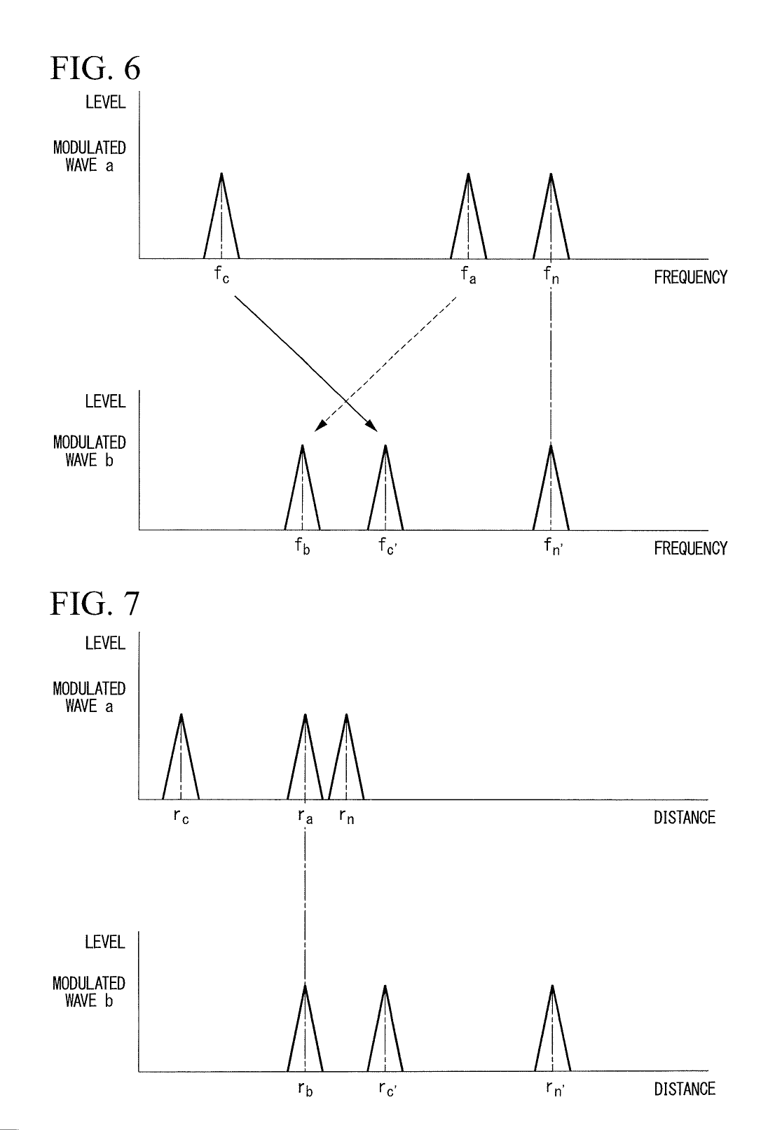

FIG. 6 is a diagram illustrating another example of the level vs. frequency characteristic of an IF signal.

In FIG. 6, the horizontal axis represents the frequency and the vertical axis represents the level.

The upper part of FIG. 6 shows the level of an IF signal in the ascending portion of modulated wave “a”. The level of the IF signal has peaks at frequencies f_{c}, fₐ, and fₙ. The frequency fₐ represents the peak frequency of an IF signal when a reflected wave reflected by a single object is used as a reception signal. The frequency fₙ represents the peak frequency of noise. The frequency f_{c} represents the peak frequency of a frequency difference component between the IF signal based on the reflected wave and the noise. Therefore, the frequency f_{c} is equal to the difference between the frequency fₙ and the frequency fₐ.

The lower part of FIG. 6 shows the level of the IF signal in the ascending portion of modulated wave “b”. The level of the IF signal has peaks at frequencies f_{b}, f_{c′}, and f_{n′}. The frequency f_{b} represents the peak frequency of an IF signal when the reflected wave reflected by the object is used as a reception signal. Therefore, the frequency f_{b} is inversely proportional to the modulation period T_{b}. That is, when Tₐ<T_{b} is established, f_{b}<fₐ is established.

The frequency f_{n′} represents the peak frequency of noise and is equal to the frequency fₙ. The frequency f_{c′} represents the peak frequency of the frequency difference component between the noise and the IF signal based on the reflected wave. Therefore, the frequency f_{c′} is equal to the difference between the frequency fₙ and the frequency f_{b}. That is, when Tₐ<T_{b} is established, f_{c′}>f_{c} is established.

Therefore, when it is determined that the peak frequency corresponding to the modulated wave “a” and the peak frequency corresponding to the modulated wave “b” are equal to each other, the received intensity calculator 122 can remove the influence of noise by eliminating the peak frequency information representing the peak frequencies. Here, the received intensity calculator 122 eliminates and does not employ the frequencies f_{n′} and fₙ.

A level vs. distance characteristic obtained by converting the frequency of the horizontal axis into the distance in the level vs. frequency characteristic of the IF signal will be described. In the following example, it is assumed that the peak frequency distributions of the ascending portions and the descending portions of the modulated waves are similar to each other, for the purpose of convenience of explanation.

FIG. 7 shows a diagram illustrating an example of the level vs. distance characteristic of an IF signal.

In FIG. 7, the horizontal axis represents the distance and the vertical axis represents the level. The distances of the horizontal axis in FIG. 7 are values into which the frequencies of the horizontal axis in the upper and lower parts of FIG. 6 are converted by multiplication of c·Tₐ/(2·Δf) and c·T_{b}/(2·Δf), respectively.

The upper part of FIG. 7 shows the level of the IF signal in the ascending portion of modulated wave “a”. The level of the IF signal has peaks at distances r_{c}, rₐ, and rₙ. The distances r_{c}, rₐ, and rₙ correspond to the peak frequencies f_{c}, fₐ, and fₙ, respectively.

The lower part of FIG. 7 shows the level of the IF signal in the ascending portion of modulated wave “b”. The level of the IF signal has peaks at distances r_{b}, r_{c′}, and r_{n′}. The distances r_{b}, r_{c′}, and r_{n′} correspond to the peak frequencies f_{b}, f_{c′}, and f_{n′}, respectively. The distance r_{b} is equal to the distance rₐ.

On the other hand, the distances r_{c′} and r_{n′} are different from the distances r_{c} and rₙ, respectively.

Here, the real image determining unit 127 stores the distance information of the target, on which the distance corresponding to the modulation period Tₐ and the distance corresponding to the modulation period T_{b} are equal to each other, as distance information of a real image for each target represented by the distance information. The real image determining unit 127 determines the distance information of the target, on which the distance corresponding to the modulation period Tₐ and the distance corresponding to the modulation period T_{b} are not equal to each other, as distance information of a virtual image for each target represented by the distance information, and does not employ the distance information. Accordingly, it is possible to remove the influence of the noise and the frequency difference component from the noise.

### Detection of Orientation

A principle in which the orientation detector 126 detects an orientation of an object will be described below.

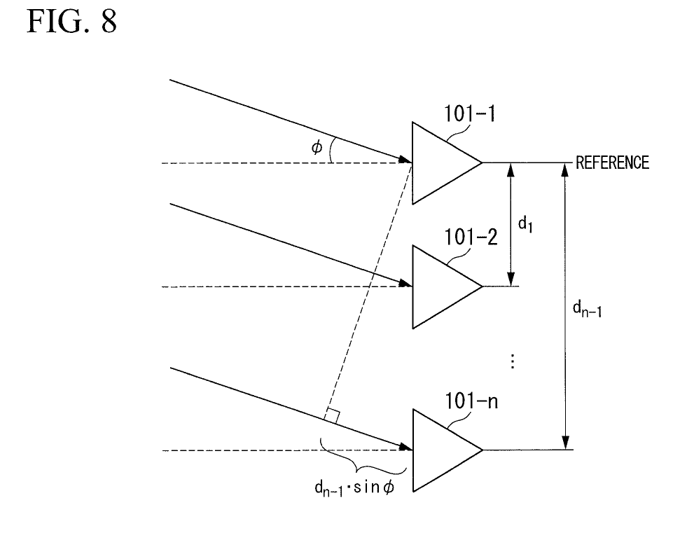

FIG. 8 is a conceptual diagram illustrating the arrangement of the receiving antennas 101-1 to 101-n according to this embodiment.

The receiving antennas 101-1 to 101-n are arranged at positions separated by intervals d₁ to dₙ₋₁ from a receiving antenna serving as a reference, for example, from the receiving antenna 101-1. When a reception signal arrives from an object located in an orientation φ about the arrangement plane of the receiving antennas 101-1 to 101-n, a phase difference occurs between the receiving antennas. The orientation φ is an angle about the axis perpendicular to the arrangement plane. For example, the phase difference between the receiving antenna 101-1 and the receiving antenna 101-n is 2πf(dₙ₋₁·sin φ/C).

The DBF unit 123 calculates the received intensity which is spectrum intensity for each channel corresponding to each orientation so as to compensate for the phase difference for the corresponding orientation φ about the reception signal for each channel. Therefore, the orientation detector 126 can estimate the orientation φ at which the received intensity calculated by the DBF unit 123 is the maximum as the orientation of the object represented by the target.

### Object Detecting Process

An object detecting process according to this embodiment will be described below.

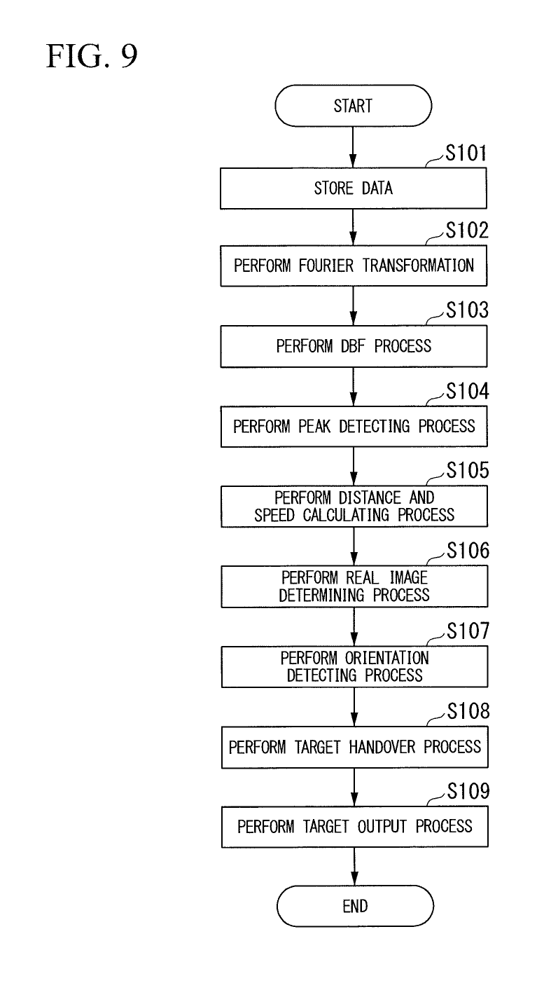

FIG. 9 is a flowchart illustrating an object detecting process according to this embodiment.

(Step S101) The VCO 111 alternately switches the modulation period to any one of Tₐ and T_{b} for each switching period T_{ab} and generates a transmission signal which is frequency-modulated with a modulation width Δf centered on a predetermined central frequency f₀. The ADC 117 converts the analog IF signals generated by mixing the reception signals and the transmission signal into digital IF signals and sequentially stores the converted IF signals in the storage unit 121 of the position information creating unit 120 (data storage). Thereafter, the process flow goes to step S102.

(Step S102) The received intensity calculator 122 Fourier-transforms the IF signal for each channel from the storage unit 121 and calculate complex data in the frequency domain. The received intensity calculator 122 outputs the calculated complex data for each channel to the DBF unit 123. Thereafter, the process flow goes to step S103.

(Step S103) The DBF unit 123 further Fourier-transforms the complex data for each channel input from the received intensity calculator 122 in the arrangement direction of the antennas and generates complex data in the spatial frequency domain. The DBF unit 123 calculates the received intensity for each predetermined angular channel based on the generated complex data and creates received intensity information representing the calculated received intensity. The DBF unit 123 outputs the generated received intensity information to the orientation detector 126.

Thereafter, the process flow goes to step S104.

(Step S104) The received intensity calculator 122 calculates a spectrum based on the sum value obtained by adding the complex data of all the channels. The received intensity calculator 122 detects a portion, at which the level is greater than a predetermined threshold value of the level and is the maximum, as the peak of the signal level in each of the ascending portion and the descending portion for each modulation periods T₃ and T_{b} from the calculated spectrum. The received intensity calculator 122 creates peak frequency information representing the frequency of the detected peak and outputs the created peak frequency information to the distance detector 124 and the speed detector 125.

The received intensity calculator 122 may determine whether the peak frequency corresponding to the modulation period Tₐ and the peak frequency corresponding to the modulation period T_{b} are equal to each other, and may eliminate and exclude the peak frequency information representing the peak frequency on which both are determined to be equal from the output target. Thereafter, the process flow goes to step S105.

(Step S105) The distance detector 124 calculates the distance R to an object represented by each target for each of the modulation periods Tₐ and T_{b}, for example, using Equation (1) based on the frequency fᵤ of the ascending portion and the frequency f_{d} of the descending portion represented by the peak frequencies input from the received intensity calculator 122. The distance detector 124 outputs distance information representing the calculated distance R for each target to the real image determining unit 127.

The speed detector 125 calculates the relative speed V to an object represented by each target for each of the modulation periods Tₐ and T_{b}, for example, using Equation (2) based on the frequency fᵤ of the ascending portion and the frequency f_{d} of the descending portion represented by the peak frequencies input from the received intensity calculator 122. The speed detector 125 outputs speed information representing the calculated relative speed V for each target to the real image determining unit 127. Thereafter, the process flow goes to step S106.

(Step S106) The real image determining unit 127 determines whether the distance to each target in the modulation period Tₐ and the distance to the corresponding target in the modulation period T_{b} represented by the distance information input from the distance detector 124 are equal to each other. The real image determining unit 127 stores the distance information of the target on which the calculated distances are determined to be equal to each other as distance information of a real image. Here, the real image determining unit 127 stores the distance information representing one of the distance corresponding to the modulation period Tₐ and the distance corresponding to the modulation period T_{b} or an average value thereof:

The real image determining unit 127 is supplied with the speed information from the speed detector 125 and stores the speed information of the target corresponding to the stored distance information as speed information of a real image. The real image determining unit 127 outputs the distance information stored as the distance information of a real image and the speed information to the target handover unit 128. Thereafter, the process flow goes to step S107.

(Step S107) The orientation detecting unit 126 detects the angle at which the received intensity represented by the received intensity information input from the DBF unit 123 is the maximum as the orientation of the object represented by the target, and creates orientation information representing the detected orientation. The orientation detector 126 outputs the created orientation information to the target handover unit 128. Thereafter, the process flow goes to step S108.

(Step S108) The distance information and the speed information from the real image determining unit 127 and the orientation information from the orientation detector 126 are input as position information to the target handover unit 128. The target handover unit 128 reads the position information in the previous modulation period from the storage unit 121. When the difference between the position information calculated in the current modulation period and the position information calculated in the previous modulation period is smaller than a predetermined threshold value, the target handover unit 128 determines that the object in the current modulation period and the object in the previous modulation period are the same. In this case, the target handover unit 128 stores the target in the storage unit 121 in correlation with the position information in the current modulation period and outputs the stored information to the target output unit 129.

When it is determined that the target in the current modulation period and the target in the previous modulation period are not the same, the target handover unit 128 creates a new target, stores the created target in the storage unit 121 in correlation with the position information in the current modulation period, and outputs the stored information to the target output unit 129. Thereafter, the process flow goes to step S109.

(step S109) The target output unit 129 outputs the position information input from the target handover unit 128 to the control instructing unit 13. Thereafter, the process flow is ended.

A real image determining process which is performed by the real image determining unit 127 will be described below.

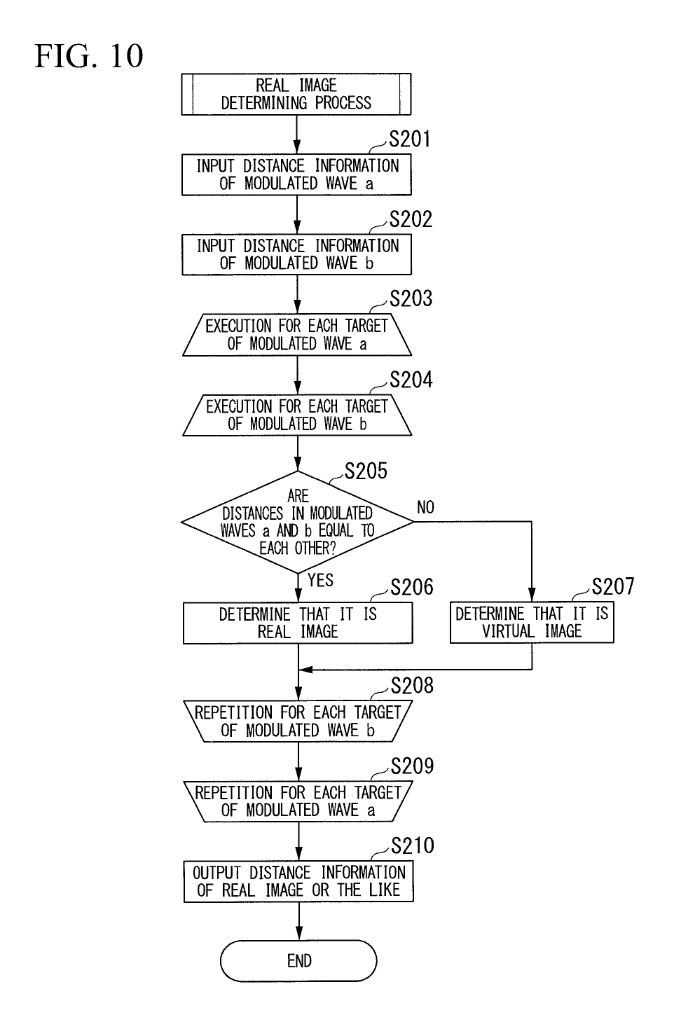

FIG. 10 is a flowchart illustrating a real image determining process according to this embodiment.

(Step S201) The distance information in the modulation period Tₐ (modulated wave “a”) is input to the real image determining unit 127 from the distance detector 124. Thereafter, the process flow goes to step S202.

(Step S202) The distance information in the modulation period T_{b} (modulated wave “b”) is input to the real image determining unit 127 from the distance detector 124.

Thereafter, the process flow goes to step S203.

(Step S203) The processes of steps S204 to S208 are performed for each target (referred to as target a) represented by the distance information in the modulation period Tₐ (modulated wave “a”).

(Step S204) The processes of steps S205 to S207 are performed for each target (referred to as target b) represented by the distance information in the modulation period T_{b} (modulated wave “b”).

(Step S205) The real image determining unit 127 determines whether the target a represented by the distance information in the modulation period Tₐ (modulated wave “a”) and the target b represented by the distance information in the modulation period T_{b} (modulated wave “b”) are equal to each other. When it is determined that the calculated distances are equal to each other (Y in step S205), the process flow goes to step S206. When it is determined that the calculated distances are not equal to each other (N in step S205), the process flow goes to step S207.

(Step S206) The real image determining unit 127 determines the distance information of the target 1 or 2, on which the calculated distances are determined to be equal to each other, to be the distance information of a real image, and stores the distance information of the target a in the modulation period Tₐ or the distance information of the target b in the modulation period T_{b}. Thereafter, the process flow goes to step S208.

(Step S207) The real image determining unit 127 determines the distance information of the target a and the distance information of the target b, on which the calculated distances are determined to not be equal to each other, as the distance information of a virtual image and eliminates the distance information. Thereafter, the process flow goes to step S208.

(Step S208) The target b to be processed is changed to a non-processed target represented by the distance information in the modulation period T_{b} (modulated wave “b”) and the process flow goes to step S204. When there is not such a target, the process flow goes to step S209.

(Step S209) The target a to be processed is changed to a non-processed target represented by the distance information in the modulation period Tₐ (modulated wave “a”) and the process flow goes to step S203. When there is not such a target, the process flow goes to step S210.

(Step S210) The speed information is input to the real image determining unit 127 from the speed detector 125. The real image determining unit 127 stores the speed information of the target represented by the stored distance information as the speed information of a real image. The real image determining unit 127 eliminates the speed information of the target on which the calculated distances are determined to not be equal to each other. The real image determining unit 127 outputs the distance information stored as the distance information of a real image and the speed information thereof to the target handover unit 128. Thereafter, the process flow is ended.

In this way, according to this embodiment, the IF signals are generated based on the transmission signal which is frequency-modulated in multiple modulation periods and the reception signals thereof and the distance to the object represented by each target is calculated based on the peak frequencies of the generated IF signals. According to this embodiment, it is determined whether or not the calculated distances of each target corresponding to modulation periods Tₐ and T_{b} are equal to each other. Accordingly, since the distance calculated based on the reception signals reflected from an object and the distance calculated based on unknown noise or the like can be distinguished, the frequency range in which the distance or the relative speed can be detected is not restricted.

### Second Embodiment

A second embodiment of the present invention will be described below. Elements or processes common to the first embodiment will be referenced by the same reference numerals and differences from the first embodiment will be mainly described below.

A motion control system 2 according to this embodiment includes an object detecting device 21 instead of the object detecting device 11 in the motion control system 1 (FIG. 1) and further includes receiving antennas 101-2-1 to 101-2-n.

The object detecting device 21 according to this embodiment simultaneously transmits transmission signals which have been frequency-modulated in different modulation periods Tₐ and T_{b}, unlike the object detecting device 11 (FIG. 2). The configuration of the object detecting device 21 will be described below.

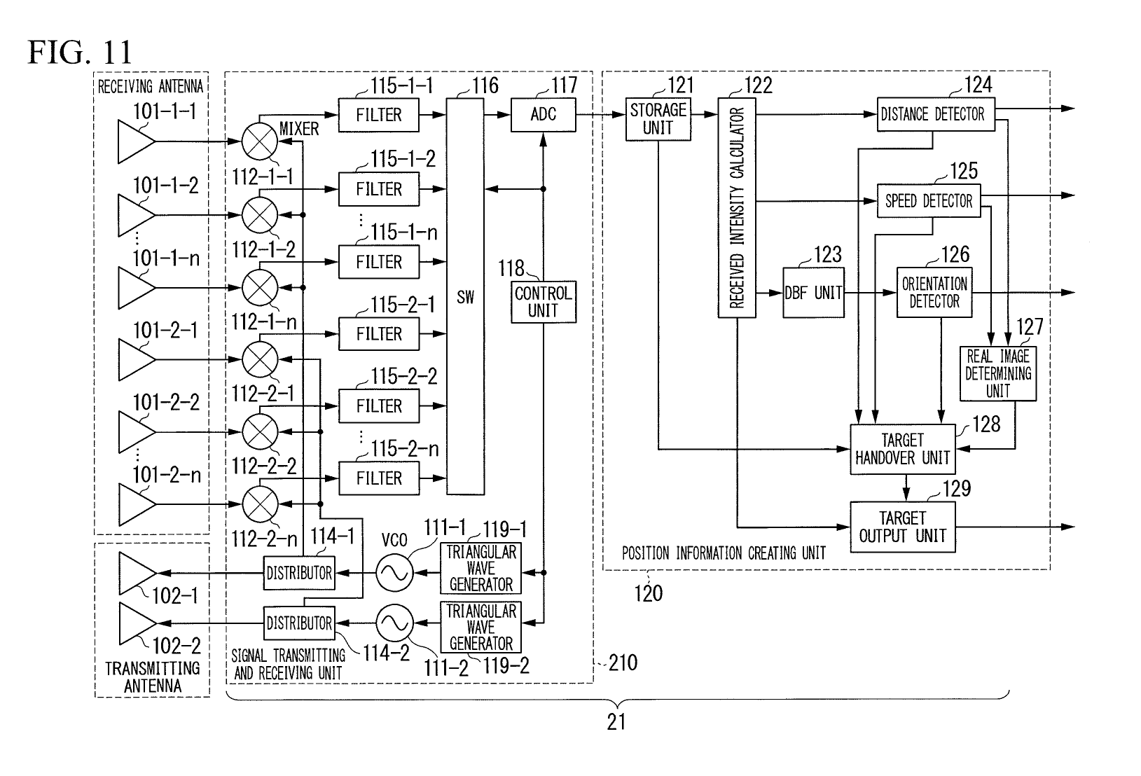

FIG. 11 is a diagram schematically illustrating the configuration of the object detecting device 21 according to this embodiment.

The object detecting device 21 includes a signal transmitting and receiving unit 210 and a position information creating unit 120.

The signal transmitting and receiving unit 210 includes VCOs 111-1 and 111-2, 2n mixers 112-1-1 to 112-1-n and 112-2-1 to 112-2-n, two distributors 114-1 and 114-2, 2n filters 115-1-1 to 115-1-n and 115-2-1 to 115-2-n, a SW 116, an ADC 117, a control unit 118, and triangular wave generators 119-1 and 119-2.

The triangular wave generators 119-1 and 119-2 generate triangular waves with modulation periods Tₐ and T_{b}, respectively, and output the generated triangular waves to the VCOs 111-1 and 111-2, respectively.

The VCOs 111-1 and 111-2 create transmission signals based on the triangular waves input from the triangular wave generators 119-1 and 119-2. Here, the frequency bands of the transmission signals generated by the triangular wave generators 119-1 and 119-2 are, for example, [f₀−Δf/2f₀+Δf/2] and [f₁−Δf/2f₁+Δf/2] (where f₁>f₀−2Δf), which are different from each other. By setting the frequency bands of both transmission signals to be different from each other, it is possible to avoid cross-talk of both. The VCOs 111-1 and 111-2 output the generated transmission signals to the transmitting antennas 102-1 and 102-2, respectively. The VCOs 111-1 and 111-2 output the generated transmission signals to the mixers 112-1-1 to 112-1-n and 112-2-1 to 112-2-n, respectively.

The mixers 112-1-1 to 112-1-n mix the reception signals from the receiving antennas 101-1-1 to 101-1-n with the transmission signal input from the distributor 114-1 to generate IF signals of channels CH-1-1 to CH-1-n. The mixers 112-1-1 to 112-1-n outputs the generated IF signals of channels CH-1-1 to CH-1-n to the filters 115-1-1 to 115-1-n.

The mixers 112-2-1 to 112-2-n mix the reception signals from the receiving antennas 101-2-1 to 101-2-n with the transmission signal input from the distributor 114-2 to generate IF signals of channels CH-2-1 to CH-2-n. The mixers 112-2-1 to 112-2-n outputs the generated IF signals of channels CH-2-1 to CH-2-n to the filters 115-2-1 to 115-2-n.

The filters 115-1-1 to 115-1-n band-limit the IF signals of channels CH-1-1 to CH-1-n input from the mixers 112-1-1 to 112-1-n, respectively, and output the band-limited IF signals of the modulation period Tₐ (modulated wave “a”) to the SW 116.

The filters 115-2-1 to 115-2-n band-limit the IF signals of channels CH-2-1 to CH-2-n input from the mixers 112-2-1 to 112-2-n, respectively, and output the band-limited IF signals of the modulation period T_{b} (modulated wave “b”) to the SW 116.

The SW 116 outputs the IF signals of channels CH-1-1 to CH-1-n and CH-2-1 to CH-2-n input from the filters 115-1-1 to 115-1-n and 115-2-1 to 115-2-n to the ADC 117 while sequentially switching the channels in synchronization with the sampling signal input from the control unit 118.

Accordingly, the signal transmitting and receiving unit 210 generates IF signals based on the transmission signals which are frequency-modulated in the modulation periods Tₐ and T_{b} and outputs the generated IF signals to the position information creating unit 120. The IF signals are output to the position information creating unit 120, for example, simultaneously. In this embodiment, the position information creating unit 120 calculates the distance to each object represented by each target based on the peak frequencies of the input IF signals and determines whether or not the distances of each target corresponding to modulation periods Tₐ and T_{b} are equal to each other. Accordingly, in this embodiment, it is possible to distinguish the distance calculated based on the reception signals reflected from an object represented by the target from the distance calculated based on unknown noise, without switching the modulation periods Tₐ and T_{b} at a predetermined time interval.

An example where there are two modulation periods has been described above, but the number of modulation periods may be larger than 2 in the above-mentioned embodiment.

It has been described above that the driving assist controller 14 includes the warning sound controller 141, the brake controller 142, and the accelerator controller 143, but the above-mentioned embodiment is not limited to this configuration. The driving assist controller 14 has only to have a configuration for controlling enabling or disabling of a motion based on the position information of a detected object, that is, an inter-vehicle distance controller.

A part of the object detecting devices 11 and 21 in the above-described embodiment, for example, the control unit 118, the received intensity calculator 122, the DBF unit 123, the distance detector 124, the speed detector 125, the orientation detector 126, the real image determining unit 127, the target handover unit 128, and the target output unit 129 may be realized by a computer. In this case, a program for realizing the control function may be recorded on a computer-readable recording medium, and the program recorded on the recording medium may be read by a computer system for execution. Here, the “computer system” may be a computer system built in the object detecting devices 11 and 21, and may include hardware such as an OS or peripherals. Furthermore, the “computer-readable recording medium” refers to a removable medium such as a flexible disk, a magneto-optical disc, a ROM or a CD-ROM, or a storage device such as a hard disk built in the computer system. Furthermore, the “computer-readable recording medium” may include a medium that dynamically stores a program for a short time, such as a communication cable in a case where the program is transmitted through a network such as the internet or a communication line such as a telephone line, or a medium that stores, in this case, the program for a specific time, such as a volatile memory inside a computer system including a server and a client. Furthermore, the program may be a program that realizes a part of the above-described functions, or may be a program that realizes the above-described functions by combination with a program that is recorded in advance in the computer system.

Furthermore, a part or all of the object detecting devices 11 and 21 according to the above-described embodiment may be realized as an integrated circuit such as an LSI (Large Scale Integrated) circuit. The respective function blocks of the object detecting devices 11 and 21 may be individually realized as a processor, or a part or all thereof may be integrated into a processor. Furthermore, a method of implementing the integration circuit is not limited to the LSI, and may be realized as a dedicated circuit or a general purpose processor. Furthermore, in a case where an integration circuit technique as a replacement for the LSI appears according to technological advances, an integration circuit according to the technique may be used.

As described above, the embodiments of the invention have been described in detail with reference to the accompanying drawings, but a specific configuration is not limited to the above description, and various design changes may be made in a range without departing from the spirit of the invention.

What is claimed is:

1. An object detecting device comprising:
a signal transmitting and receiving unit configured to generate intermediate frequency signals based on transmission signals obtained by frequency modulation in multiple modulation periods and reception signals corresponding to reflected waves of the transmission signals;
a distance detecting unit configured to calculate distances based on peak frequencies of the intermediate frequency signals generated by the signal transmitting and receiving unit; and
a determination unit configured to determine whether or not the distances calculated by the distance detecting unit and corresponding to the multiple modulation periods are equal to each other.

2. The object detecting device according to claim 1, wherein the determination unit determines that the distances are based on a real image when the distances are determined to be equal to each other, and determines that the distances are not based on a real image and are invalid when the distances are determined to not be equal to each other.

3. The object detecting device according to claim 1, further comprising a received intensity calculating unit configured to determine whether or not the peak frequencies are equal to each other.

4. The object detecting device according to claim 3, wherein the received intensity calculating unit determines that the peak frequencies are based on noise and are invalid when the peak frequencies are determined to be equal to each other.

5. The object detecting device according to claim 1, wherein the signal transmitting and receiving unit switches a period used in frequency modulation of the transmission signals from one to another of the multiple modulation periods at a predetermined time interval.

6. The object detecting device according to claim 1, wherein the signal transmitting and receiving unit comprises:
transmitting units allotted to each of the multiple modulation periods and configured to transmit the transmission signals; and
receiving units allotted to each of the multiple modulation periods and configured to receive the reflected waves.

7. An object detecting method comprising:
a first step of generating intermediate frequency signals based on transmission signals obtained by frequency modulation in multiple modulation periods and reception signals corresponding to reflected waves of the transmission signals;
a second step of calculating distances based on peak frequencies of the intermediate frequency signals; and
a third step of determining whether or not the distances corresponding to the multiple modulation periods are equal to each other.

8. An object detecting program causing a computer of an object detecting device to perform:
a sequence of generating intermediate frequency signals based on transmission signals obtained by frequency modulation in multiple modulation periods and reception signals corresponding to reflected waves of the transmission signals;
a sequence of calculating distances based on peak frequencies of the intermediate frequency signals; and
a sequence of determining whether or not the distances corresponding to the multiple modulation periods are equal to each other.

9. A motion control system comprising an object detecting device and a motion control unit configured to control a motion based on a distance or a speed of an object input from the object detecting device,
wherein the object detecting device comprises:
a signal transmitting and receiving unit configured to generate intermediate frequency signals based on transmission signals obtained by frequency modulation in multiple modulation periods and reception signals corresponding to reflected waves of the transmission signals;
a distance detecting unit configured to calculate distances based on peak frequencies of the intermediate frequency signals generated by the signal transmitting and receiving unit; and
a determination unit configured to determine whether or not the distances calculated by the distance detecting unit and corresponding to the multiple modulation periods are equal to each other.
